(19) United States
(12) Patent Application Publication
(10) Pub. No.: US 2016/0112438 A1
(43) Pub. Date: Apr. 21, 2016

(54) SECURE MESSAGING IN MESSAGE-ORIENTED SYSTEMS

(71) Applicants: Christian Hengstler, Dresden (DE); Volodymyr Vasyutynskyy, Dresden (DE); Martin Rosjat, Dresden (DE); Stefan Hesse, Dresden (DE)

(72) Inventors: Christian Hengstler, Dresden (DE); Volodymyr Vasyutynskyy, Dresden (DE); Martin Rosjat, Dresden (DE); Stefan Hesse, Dresden (DE)

(21) Appl. No.: 14/516,796

(22) Filed: Oct. 17, 2014

(51) Int. Cl. H04L 29/06; H04L 12/58

(52) U.S. Cl. CPC H04L 63/123; H04L 51/12

(57) ABSTRACT

Implementations of the present disclosure include methods, systems, and computer-readable storage mediums for providing secure messaging in message-oriented systems. Actions can include: receiving, by the one or more processors, one or more subscribe requests from one or more subscriber devices; receiving, by the one or more processors, at least one publish request from at least one publisher device, the publisher and subscriber devices being loosely coupled through the broker device on a shared cloud platform; validating, by the one or more processors, the at least one publish request and the one or more subscribe requests to provide validation results; and determining, by the one or more processors, a message routing schedule based at least in part on the validation results.

### BACKGROUND

Distributed software applications hosted on cloud computing platforms can incorporate message oriented middleware (MOM). In some examples, MOM facilitates communication, connectivity and integration between the various application components across the platform by exchanging messages at a central broker. Generally, the broker supports a publish-subscribe pattern where application components can publish messages to one or more topics maintained at the broker, and subscribe to various topics in order to receive messages published by other application components. In some MOM systems, the fundamental authentication and authorization mechanisms for regulating the distribution of messages are provided at the topic level of the publish-subscribe paradigm. As one example, a subscriber interested in receiving messages published at a certain topic may be required to comply with certain security measures in order to establish the subscription.

### SUMMARY

Implementations of the present disclosure include computer-implemented methods for providing secure messaging in message-oriented systems (e.g., cloud-based systems, distributed systems deployed on local area networks, and systems deployed on stand-alone computing devices), the methods being performed by one or more processors. In some implementations, methods include actions of: receiving, by the one or more processors, one or more subscribe requests from one or more subscriber devices; receiving, by the one or more processors, at least one publish request from at least one publisher device, the publisher and subscriber devices being loosely coupled through the broker device on a shared cloud platform; validating, by the one or more processors, the at least one publish request and the one or more subscribe requests to provide validation results; and determining, by the one or more processors, a message routing schedule based at least in part on the validation results.

These and other implementations can each optionally include one or more of the following features: The at least one publish request and each of the one or more subscribe requests may include a reference to a topic hosted at a broker device on the cloud platform.

The present disclosure also provides one or more non-transitory computer-readable storage media coupled to one or more processors and having instructions stored thereon which, when executed by the one or more processors, cause the one or more processors to perform operations in accordance with implementations of the methods provided herein. The at least one publish request may further include data describing a message to-be-published at the topic. The message may include a metadata section and a payload section, and the data included in the publish request may describe at least one of: one or more attribute values included in the metadata section; and content included in the payload section. Each of the one or more subscribe requests may further include data describing at least one of: one or more attribute values that must be included in the metadata section of messages to be delivered according to the subscription; and content that must be included in the payload section of messages to be delivered according to the subscription. Validating the at least one publish request may include: accessing a security repository to obtain publisher permissions data; and determining whether the publish request should be granted based on the publisher permissions data. The publisher permissions data may relate to data included in the publish request. Validating the one or more subscriber requests may include: accessing a security repository to obtain subscriber permissions data; and determining whether the subscribe request should be granted based on the subscriber permissions data. The subscriber permissions data may relate to data included in the subscribe request. The methods may further include the actions of: in response to determining that the subscribe request should not be granted, determining a modified subscribe request based on the validation results. Determining a routing schedule may include publishing a message associated with a validated publish request. Determining a routing schedule may include identifying one or more messages that satisfy a validated subscribe request. The broker device may be incorporated in a cloud-based system.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system architecture in accordance with implementations of the present disclosure.

FIG. 2A depicts an example system for providing secure messaging in message-oriented systems.

FIG. 2B depicts an example published message in accordance with implementations of the present disclosure.

FIG. 3 depicts an example process for processing a publication request in accordance with implementations of the present disclosure.

FIG. 4 depicts an example process for processing a subscription request in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

### DETAILED DESCRIPTION

Implementations of the present disclosure are generally directed to systems, methods, and computer-readable media for providing secure messaging in message-oriented systems (e.g., cloud-based systems as described herein, as well as distributed systems deployed on local area networks, and systems deployed on stand-alone computing devices). In some implementations, one or more publish requests and one or more subscribe requests are received by a broker device. The publish requests and the subscribe requests may be received from respective publisher and subscriber devices loosely coupled to one another through the broker device on a shared cloud platform. In some examples, loose coupling between devices is established by the broker facilitating communication between the devices. For example, the broker device may be operable to communicate messages between the publisher device and the subscriber device based on the publish request and the subscribe request. In some implementations, the broker device may provide one or more security measures and/or filtering measures on a message-by-message basis based on the publish and subscribe requests.

In some implementations, the broker device validates both the publish request(s) and the subscribe request(s), and determines an appropriate message routing schedule at least partially based on the result(s) of the validation. In some implementations, validation of the publish and subscribe requests is performed by accessing a security repository including publisher and subscriber permissions data. The security repository may be operable to provide relevant permissions data indicating whether the publish request and/or the subscribe request should be granted.

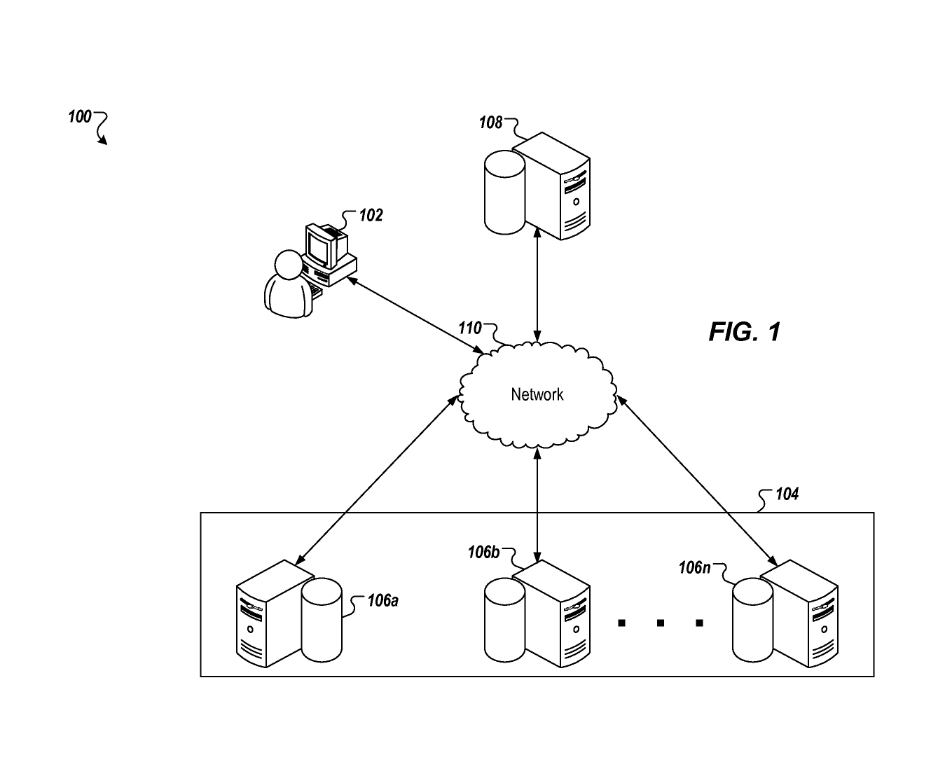

FIG. 1 depicts an example system architecture 100 in accordance with implementations of the present disclosure. The example system architecture 100 includes a client-side computing device (client device) 102, a cloud platform 104 that supports a plurality of server-side computing device (server devices) 106a-n, a broker computing device (broker device) 108, and a network 110. In general, the term “computing device” refers to any appropriate type of data processing device capable of running operating systems and application programs to perform server and/or client functions. Example computing devices can include a general-purpose personal computer (PC), Macintosh, workstation, UNIX-based workstation, a blade server, a handheld computer, a tablet computing device, a personal digital assistant (PDA), a smartphone, or any appropriate combination of any two or more of these data processing devices or other data processing devices. While the following discussion is presented in context of the system architecture 100, other appropriate environments and components are also contemplated within the scope of the present disclosure. For example, one or more implementations may be deployed on a stand-alone computing device where the publisher(s), broker(s), and subscriber(s) are incorporated in the same physical machine.

In this example, the client device 102 represents a user in a cloud-computing environment. In some implementations, the client device 102 may be operable by a user as part of a business process involving one or more distributed applications associated with the cloud platform 104. In some implementations, the client device 102 may be operable by a remote developer associated with the cloud platform 104. In this example, the server devices 106a-n represent distributed-application servers integrated by loose coupling on the shared cloud platform 104. Thus, the client device 102 and the respective server devices 106a-n can communicate with one another over the network 110 by exchanging information contained in messages through the broker device 108, while having little or no knowledge of the definitions of the other separate components. So, for example, in a loosely coupled system, the server devices 106a and 106b can blindly exchange messages through the broker device 108 without any direct interaction. The network 110 can include a large computer network, such as a local area network (LAN), a wide area network (WAN), the Internet, a cellular network, or a combination thereof connecting any number of mobile computing devices, fixed computing devices and server systems. Further, in some implementations, the network 110 can be provided in the form of the internal bus system of a computing device. In some implementations a “message,” may include any container suitable for conveying data from a source to a destination.

For purposes of illustration, and as discussed in further detail below, a user can use the client device 102 to interact with distributed applications (e.g., business software products) hosted by the server devices 106a-n. Thus, in this example, each of the server devices 106a-n includes an application component established on the cloud platform 104, e.g., an application, a processing resource, and/or a database. Application components hosted on one or more of the respective server devices 106a-n may be integrated with one another across the cloud platform 104. For example, two or more application components can communicate and collaborate with one another in response to and in connection with one or more requests received from the client device 102. In some implementations, the distributed application provided by the server devices 106a-n on the cloud platform 104 is a web-based application accessed and executed by the client device 102 through the network 110. Regardless of the particular implementation, an “application” may include computer-readable instructions, firmware, wired or programmed hardware, or any combination thereof on a tangible and non-transitory medium operable when executed by one or more processors to perform at least the protocols, processes and operations described herein.

In some implementations, proprietary on-demand business process platforms can be used to create various on-demand software products built using at least a portion of the platform. In some implementations, on-demand products can be a fully integrated enterprise resource planning (ERP), or business management software solutions. The on-demand products can be a complete SaaS (software as a service) system in which software and its associated data are hosted centrally (for example, in the cloud platform 104), and are accessed by users using a thin client (e.g., a web browser) over the internet. Further, in some implementations, the distributed applications hosted by the server devices 106a-n may facilitate various other types of licensing and delivery models, including: infrastructure as a service (IaaS), platform as a service (PaaS), software as a service (SaaS), storage as a service (STaaS), security as a service (SECaaS), data as a service (DaaS), business process as a service (BPaaS), test environment as a service (TEaaS), desktop as a service (DaaS), and/or application programming interfaces (API) as a service (APIaaS).

In some implementations, the broker device 108 facilitates asynchronous message communication between the client device 102 and the server devices 106a-n. For example, the broker device may control the formatting, scheduling, and routing of messages between the server devices 106a-n according to a publish-subscribe paradigm. Accordingly, the broker device 106 may receive and process blind publish and subscribe requests from the server devices 106a-n. For purposes of clarity, throughout the present disclosure, a device submitting a publish request to the broker device 108 may be referred to as a “publisher device,” and a device submitting a subscribe request may be referred to as a “subscriber device.” In this arrangement, the publisher device or the subscriber device operates without knowledge of what, if any, other subscribers or publishers exist on the cloud platform. In some implementations, the broker device 108 can use a suitable messaging architecture for supporting publishing and subscribing, e.g., Java Message Service (JMS). Further, and as described in detail below, in some implementations, the broker device 108 can facilitate secure messaging in a cloud-based publisher-subscriber environment on a message-by-message basis.

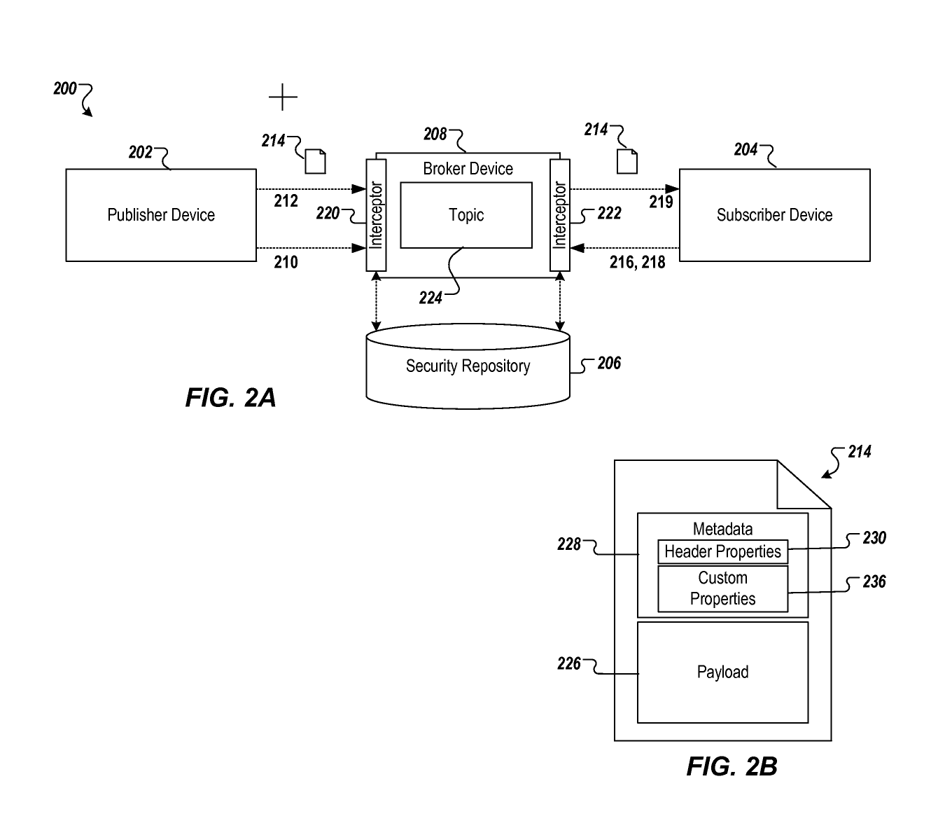

FIG. 2A depicts an example system 200 for providing secure messaging in message-oriented systems. As shown, the system 200 includes a publisher device 202, a subscriber device 204, a security repository 206, and a broker device 208. In this configuration of the system 200, the broker device 208 facilitates asynchronous communication of messages between the publisher device 202 and the subscriber device 204. Although the example system 200 is illustrated as including a single publisher device 202 and a single subscriber device 204, the present disclosure is not so limited. The illustration provided in FIG. 2A is simplified for clarity and ease of understanding. In some implementations, the broker device 208 is capable of facilitating asynchronous communication between numerous publisher and subscriber devices.

In this example, the publisher device 202 connects (210) to the broker device 208 and submits (212) a publish request for publishing a message 214 (see FIG. 2B) to a topic 224. In some examples, the topic 224 is a data structure maintained or “hosted” by the broker device 208 for organizing published messages for distribution. As described below, the topic 224 is accessible through the broker device 208 by one or more subscriber devices (e.g., the subscriber device 204). In some implementations, the message 214 can be incorporated in the publish request or submitted to the broker device 208 in a separate transmission. As one example, the message 214 itself can be received and interpreted by the broker device 208 as a publish request. The subscriber device 204 connects (216) to the broker device 208 and submits (218) a subscribe request to receive messages published to the topic 224 (e.g., the message 214) by various publisher devices (e.g., the publisher device 202).

The topic 224 provides an address at the broker device 208 for receiving and distributing the message 214. Thus, the publisher device 202 can publish the message 214 at the broker device 208 by referencing the topic 224 and the subscriber device can subscribe to the message 214 at the broker device 208 by referencing the same topic 224. In some implementations, the broker device 208 may host several different topics for routing messages between publisher and subscriber devices throughout the cloud platform. In some implementations, various topics hosted by the broker device 208 can be arranged according to an hierarchical data structure (e.g., a topic tree), such that a publication request referencing the topic 224 may also be interpreted by the broker device 208 as a publication request directed to one or more other related topics. Thus, various implementations discussed below relating to the validation of a publish request may be performed iteratively or simultaneously across a plurality of topics in connection with a single publication request.

The broker device 208 includes a publish-side interceptor 220 and a subscribe-side interceptor 222. The publish-side interceptor 220 receives (or “intercepts”) the publish request submitted (212) to the broker device 208 by the publisher device 202. In some implementations, the publish request may include information describing the nature of the to-be-published message 214. As shown in FIG. 2B, the message 214 may include a payload section 226 and a metadata section 228. A publish request may include any data provided in the metadata section 228 and the payload section 226 of the message 214. The payload section 226 may include the content (e.g., text, image, or video) intended to be processed by a subscriber device (e.g., the subscriber device 204). In some implementations, the content included in the payload section 226 can be encrypted or otherwise password protected. Further, while the message 214 is depicted in this example as a stand-alone data container, in some implementations, the message 214 may include a “streaming” sequence of data containers (or “data packets”).

The metadata section 228 may include one or more header properties 230. In some examples, the metadata section 228 can include one or more custom properties 232. In some implementations, the header properties 230 may include conventional fields (e.g., name-value pairs) describing various attributes of the message 214, such as: date of message creation, message origin, message type, message modification dates, message author, payload size, and the like. As noted above, in some implementations, the message 214 may be incorporated in the publish request. Thus, the header properties 230 may also include information identifying the topic 224 at the broker device 208. In some implementations, the custom properties 232 may include data fields that contain information related to any other attributes of the message 214 that are not included in the header properties 230. As one example, the custom properties may include security-related information (e.g., security credentials, custom subscriber permissions for permitting access to the message), and/or information indicating a level of importance (e.g., a high or low importance indicator).

In response to receipt of a publish request pertaining to the message 214, the publish-side interceptor 220 accesses (226) the security repository 206 to validate the publish request. In some implementations, the publish-side interceptor 220 facilitates validation of the publish request based on publisher permissions data stored in the security repository 206. The publisher permissions data stored in the security repository 206 may include any appropriate type of data suitable for regulating the publication of messages to a topic (e.g., the topic 224) at the broker device 208. Generally, the publisher permissions data is related to data included in the publish request that relates to the message 214 (e.g., data corresponding to the metadata section 228 and the payload section 226 of the message 214). In some implementations, the publisher permissions data can be organized at the security repository 206 based on the different topics hosted at the broker device 208. For example, the publisher permissions data relating to the topic 224 may be maintained separately from the permissions data relating to one or more other topics.

In some implementations, the publisher permissions data may include one or more blacklists associated with the topic 224. In some examples, the blacklists may identify one or more attributes defined in the metadata section 228 of the message 214 that are indicative of messages that may not be permitted to publish at the topic 224. As one example, the permissions data stored at the security repository 206 may include a blacklist relating to the attributes of “message author” and “message type.” In this example, if the publish request related to the message 214 includes data specifying message-author or message-type attributes corresponding to one or more of the blacklist items, the publication request may be denied to prevent publication of the message 214 to the topic 224.

In some implementations, the publisher permissions data may include one or more whitelists associated with the topic 224. Further, in some examples, the whitelists/blacklists may include (instead of, or in addition to, message attributes) specific pieces of content or a pattern of content (e.g., a text string) identifiable in the payload section 226 of the message 214. Further still, in some implementations, the publisher permissions data may include data related to specific security credentials. In some examples, the publication request may be denied to prevent publication of the message 214 to the topic 224, unless the request includes the appropriate security credentials.

In some implementations, the security repository 206 includes a database (e.g., a relational database) operable to provide relevant publisher permissions data to the publish-side interceptor 220 in response to a query. In this case, the publish-side interceptor 220 can validate the publish request by applying the relevant publisher permissions data retrieved from the security repository 206 to the request based on one or more security protocols, and determine whether the message 214 should be permitted to publish to the topic 224 at the broker device 208 based on the validation results. In some implementations, the security repository 206 may include a comprehensive security system operable to receive data provided in the publish request and execute one or more security protocols based on the publisher permissions data to determine whether the message 214 should be permitted to be published to the topic 224. Output indicating the determination can be provided to the publish-side interceptor 220. Further, in some implementations, the security repository 206 may include a directory service organizing the permissions data with respect to different publisher devices (e.g., the publisher device 202) on the cloud platform. In this case, each publisher device on the cloud platform may be assigned specific permissions maintained at the security repository to publish messages having certain attributes and/or content to certain topics. In some implementation, further complex security rules may be implemented that include exceptions, context-based security policies, hacker attack prevention, performance balancing or combination of the security policies mentioned above.

Whether executed at the publish-side interceptor 220 or the security repository 206, validating the publish request based on permissions data can be performed according to any appropriate security protocol. In some implications, the publisher permissions data can be arranged into discrete security rules. In some examples, a publish request may only be granted to allow publication of the message if all of the security rules are passed. In some examples, the security rules can be applied to the data of the publication request to provide a numerical validation score. The validation score can be compared to a predetermined threshold value to determine whether the publication request should be granted. As noted above, the publication request referencing the topic 224 may also be interpreted as a publication request for other related topics. Denial of a publication request with respect to the topic 224 may or may not preclude publication to other related topics.

The subscribe-side interceptor 222 receives (or “intercepts) the subscribe request submitted (218) to the broker device 208 by the subscriber device 204. In some implementations, the subscribe request may include a reference to the topic 224 and information describing the nature of messages (e.g., the message 214) that the subscriber device 204 is interested in receiving. For example, the subscribe request may include one or more message attributes (e.g., date of message creation, message origin, message type, message modification dates, message author, etc. and/or one or more custom attributes) and/or specific content data pertaining to messages publishes at the topic 224. In some implementations, the subscribe request may include security credentials relating to the subscriber device 204. In some implementations, the attributes and/or content referenced in the subscriber request can be used for security purposes (e.g., validation of the subscribe request) and/or for filtering purposes. Filtering the messages transmitted to the subscriber devices based on topic subscriptions can reduce processing load and increase performance across the distributed application on the cloud platform.

Validation of a subscribe request from the subscriber device 204 can be facilitated by the subscribe-side interceptor 222 in accordance with one or more of the techniques discussed above with respect to validation of a publish request by accessing subscriber permissions data stored at the security repository 206. However, in some implementations, if a subscribe request is determined to partly satisfy the permissions-based security protocol the subscribe-side interceptor 222 may provide a suggested subscription to the subscriber device 204. The suggested subscription may be a modified version of the original subscription request that fully satisfies the security protocol. In some implementations, a subscribe request is determined to partly satisfy the security protocol for validation if some but not all of the permissions-based security tests are passed. For example, the subscriber device 204 may have the appropriate security credentials to access the topic 224, but the access may be limited to certain message types. In this example, the subscribe-side interceptor 222 may determine that the subscribe request partly satisfy the security protocol for validation, and provide a modified subscription to the topic 224 that includes only the certain message types that are accessible to the subscriber device 204 based on the subscriber permissions data stored at the security repository 206. If the subscribe request is validated, the message 214 is routed (219) to the subscriber device 204.

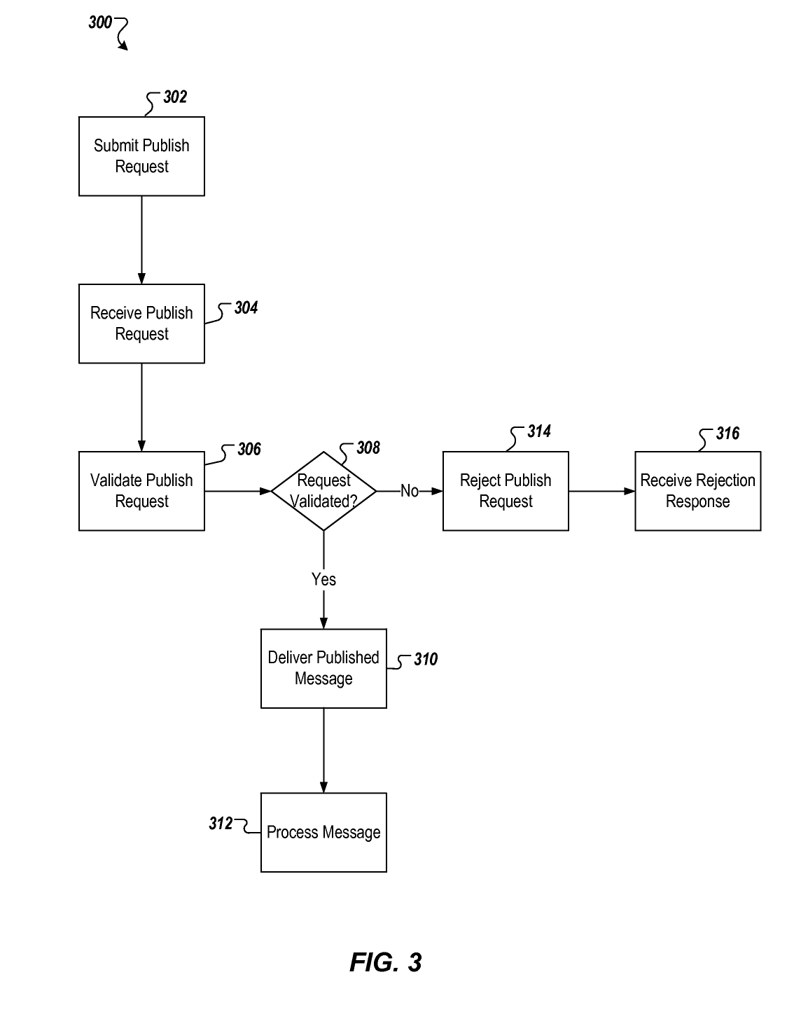

FIG. 3 depicts an example process 300 that can be executed in accordance with implementations of the present disclosure. In some examples, the example process is executed by the system 200 for processing a publish request. In some implementations, the example process 300 can be realized using one or more computer-executable applications (e.g., a distributed application) executed using one or more computing devices (e.g., a client device, a server device).

According to the process 330, a publish request is submitted (302). For example, the publisher device 202 may submit a request to publish a message to a topic hosted at the broker device 208. In some implementations, the publish request may include data describing the to-be-published message, or may include the message itself The publish request is received (304), e.g., by the publish-side interceptor 220. In response to receiving the publish request, the publish-side interceptor 220 validates (306) the publish request. In some implementations, the publish-side interceptor 220 facilitates validation of the publish request by accessing a security repository (e.g., the security repository 206) that maintains publisher permissions data relating to various topics hosted at the broker device 208. If the publish request satisfies a security protocol for validation (308), the message is published to the target topic and delivered (310) to the subscriber device 204 where it is processed (312). As described below with reference to the example protocol 400, the subscriber device 204 may have submitted a validated subscribe request to the topic at which the validated message was successfully published. On the other hand, if the publish request fails to satisfy the security protocol for validation (310), the publication request is rejected (314). The publisher device 202 receives (316) a rejection response from the publish-side interceptor 220.

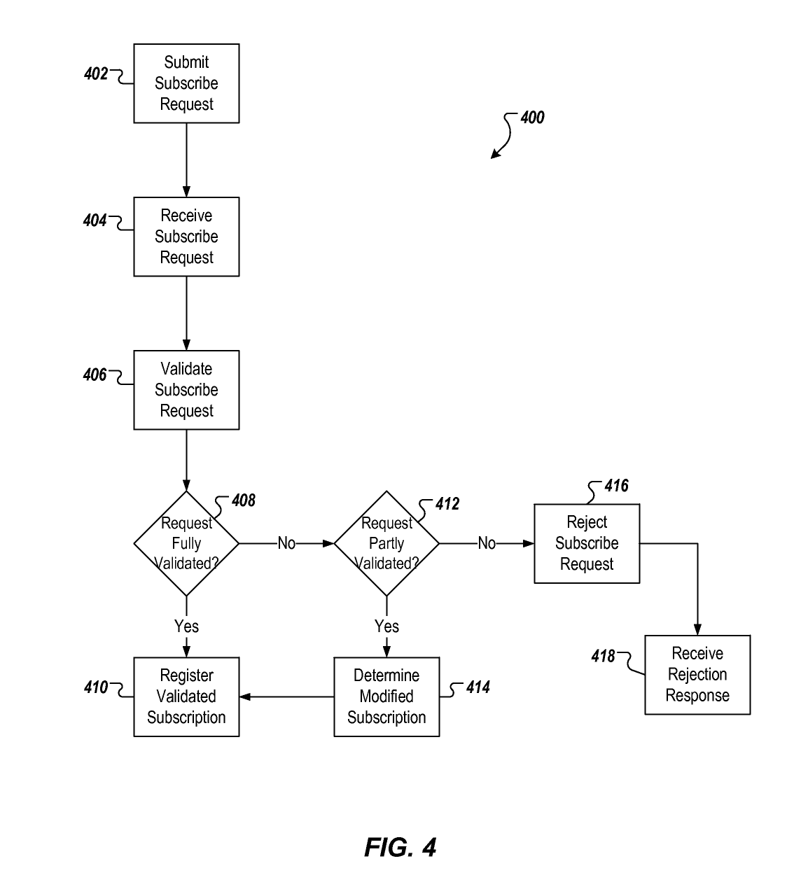

FIG. 4 depicts another example process 400 that can be executed in accordance with implementations of the present disclosure. In some examples, the example process is executed by the system 200 for processing a subscribe request. In some implementations, the example process 400 can be realized using one or more computer-executable applications (e.g., a distributed application) executed using one or more computing devices (e.g., a client device, a server device).

According to the process 400, a subscribe request is submitted (402). For example, the subscriber device 204 may submit a request to subscribe to a topic hosted at the broker device 208. In some implementations, the subscribe request may include data describing the nature of messages that the subscriber device is interested in receiving. The subscribe request is received (404), e.g., by the subscribe-side interceptor 222. In response to receiving the subscribe request, the subscribe-side interceptor 220 validates (406) the subscribe request. In some implementations, the subscribe-side interceptor 222 facilitates validation of the publish request by accessing a security repository (e.g., the security repository 206) that maintains subscriber permissions data relating to various topics hosted at the broker device 208. If the subscribe request fully satisfies a security protocol for validation (408), the validated subscription to the topic is registered (410) by the broker device 208. If the subscribe request partly satisfies the security protocol for validation (412), the subscribe-side interceptor 222 determines (414) a modified subscription that fully satisfies the security protocol. If the subscribe request fails to even partly satisfy the security protocol for validation (412), the subscribe request is rejected (416), and the subscriber device 204 receives (418) a rejection response from the subscribe-side interceptor 222.

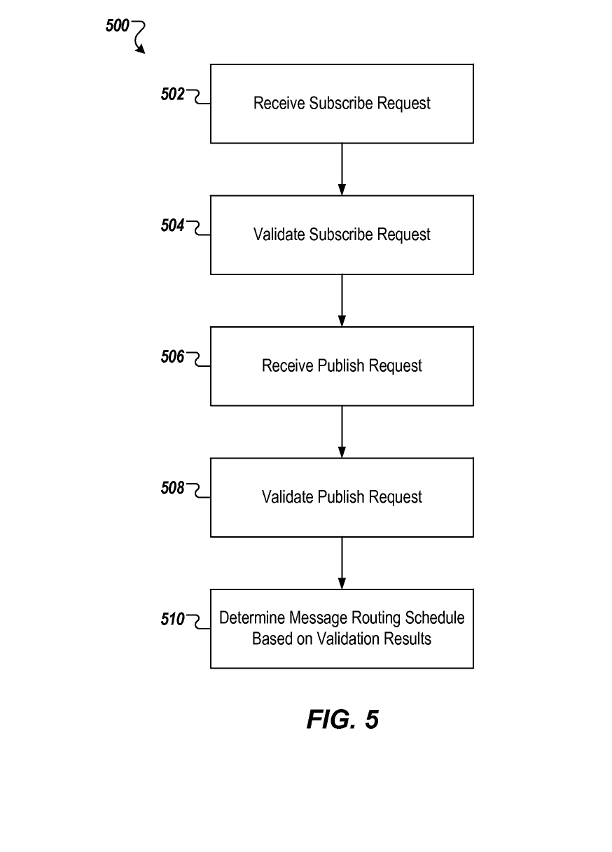

FIG. 5 depicts yet another example process 500 that can be executed in accordance with implementations of the present disclosure. In some implementations, the example process 500 can be realized using one or more computer-executable applications (e.g., a distributed application) executed using one or more computing devices (e.g., a client device, a server device).

According to the example process 500, a subscribe request is received (502). In some implementations, the subscribe request is submitted by a subscriber device and includes information indicating a subscription topic. In some implementations, the subscribe request may further include information describing one or more attributes and/or content relating to messages that the subscriber device is interested in receiving. In response to receiving the subscribe request, the subscribe request is validated (504) to produce validation results (e.g., granting, rejecting, or modifying the subscribe request). In some implementations, validating the subscribe request may include accessing subscriber permissions data from a security repository and applying the subscriber permissions data to data included in the subscribe request. In some implementations, applying the subscriber permissions data to data included in the subscribe request may include executing a security protocol including one or more security tests based on the subscriber permissions data. In some examples, the subscriber permissions data may include one or more whitelists or blacklists identifying specific message attributes and/or content. In some examples, the subscriber permissions data may include data related to security credentials. In some implementations, the subscription defined by the request can be registered at a broker device if the subscription request fully satisfies a security protocol for validation. The security protocol may be related to the subscriber permissions data stored at the security repository. In some implementations, if the subscribe request at least partly satisfies the security protocol for validation, a modified subscription that fully satisfies the security protocol can be determined.

The example process 500 further includes receiving (506) a publish request. In some implementations, the publish request is submitted by a publisher device and includes information indicating the same subscription topic as the subscribe request (or a related subscription topic). In some implementations, the publisher device and the subscriber device are loosely coupled on a shared cloud computing platform. In some implementations, the publish request includes information describing one or more attributes and/or content relating to a to-be-published message. In response to receiving the publish request, the publish request is validated (508) to produce validation results (e.g., granting or rejecting the publish request). In some implementations, validating the publish request includes accessing publisher permissions data stored at the security repository and applying the publisher permissions data to data included in the publisher request according to a publisher security protocol. Finally, a message routing schedule is determined (510) based at least in part on the validation results. For example, a broker device loosely coupling the publisher device and the subscriber device may determine a message routing schedule for distributing messages from the publisher device that have been validated on the publish-side of the broker device to the subscriber device according to subscriptions that have been validated on the subscribe-side of the broker device. In this example, the subscriber device may only be exposed to messages from the publisher device that it is interested in and for which it possesses the appropriate security clearance.

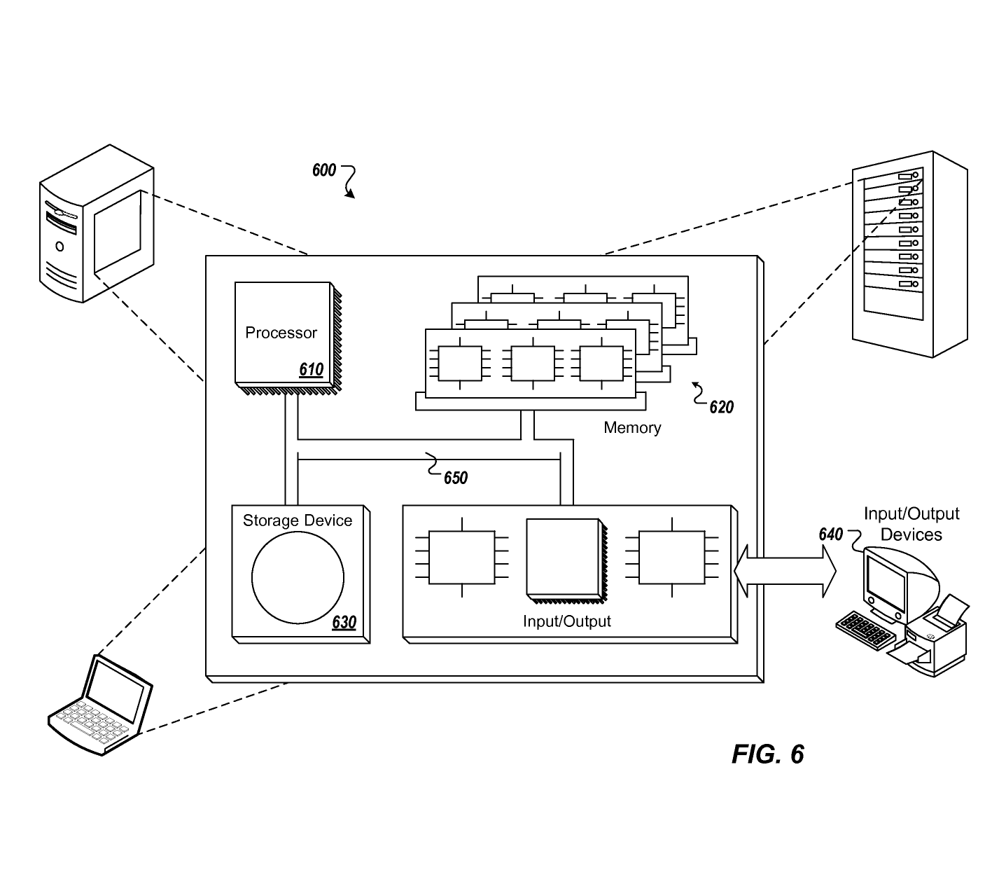

Referring now to FIG. 6, a schematic diagram of an example computing device 600 is provided. The device 600 can be used for the operations described in association with the implementations described herein. For example, the device 600 may be included in any or all of the server components discussed herein. The device 600 includes a processor 610, a memory 620, a storage device 630, and an input/output device 640. Each of the components 610, 620, 630, 640 are interconnected using a device bus 650. The processor 610 is capable of processing instructions for execution within the device 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the device 600. In one implementation, the memory 620 is a computer-readable medium. In one implementation, the memory 620 is a volatile memory unit. In another implementation, the memory 620 is a non-volatile memory unit. The storage device 630 is capable of providing mass storage for the device 600. In one implementation, the storage device 630 is a computer-readable medium. In various different implementations, the storage device 630 may be a floppy disk device, a hard disk device, an optical disk device, or a tape device. The input/output device 640 provides input/output operations for the device 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable device including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer device that includes a back-end component, such as a data server, or that includes a middleware component, such as an application server or an Internet server, or that includes a front-end component, such as a client computer having a graphical user interface or an Internet browser, or any combination of them. The components of the device can be connected by any form or medium of digital data communication such as a communication network. Examples of communication networks include, e.g., a LAN, a WAN, and the computers and networks forming the Internet.

The computer device can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing secure messaging in message-oriented systems, the method being executed using a broker device including one or more processors, the method comprising:
receiving, by the one or more processors, one or more subscribe requests from one or more subscriber devices;
receiving, by the one or more processors, at least one publish request from at least one publisher device, the publisher and subscriber devices being loosely coupled through the broker device on a shared cloud platform;
validating, by the one or more processors, the at least one publish request and the one or more subscribe requests to provide validation results; and
determining, by the one or more processors, a message routing schedule based at least in part on the validation results.

2. The method of claim 1, wherein the at least one publish request and each of the one or more subscribe requests includes a reference to a topic hosted at a broker device on the cloud platform.

3. The method of claim 2, wherein the at least one publish request further includes data describing a message to-be-published at the topic.

4. The method of claim 3, wherein the message comprises a metadata section and a payload section, and wherein the data included in the publish request describes at least one of:
one or more attribute values included in the metadata section; and
content included in the payload section.

5. The method of claim 4, wherein each of the one or more subscribe requests further includes data describing at least one of:
one or more attribute values that must be included in the metadata section of messages to be delivered according to the subscription; and
content that must be included in the payload section of messages to be delivered according to the subscription.

6. The method of claim 1, wherein validating the at least one publish request comprises:
accessing a security repository to obtain publisher permissions data; and
determining whether the publish request should be granted based on the publisher permissions data.

7. The method of claim 6, wherein the publisher permissions data relates to data included in the publish request.

8. The method of claim 1, wherein validating the one or more subscriber requests comprises:
accessing a security repository to obtain subscriber permissions data; and
determining whether the subscribe request should be granted based on the subscriber permissions data.

9. The method of claim 8, wherein the subscriber permissions data relates to data included in the subscribe request.

10. The method of claim 9, further comprising:
in response to determining that the subscribe request should not be granted, determining a modified subscribe request based on the validation results.

11. The method of claim 1, wherein determining a routing schedule comprises publishing a message associated with a validated publish request.

12. The method of claim 1, wherein determining a routing schedule comprises identifying one or more messages that satisfy a validated subscribe request.

13. The method of claim 1, where the broker device is incorporated in a cloud-based system.

14. A non-transitory computer-readable storage medium coupled to one or more processors and having instructions stored thereon which, when executed by the one or more processors, cause the one or more processors to perform operations for providing secure messaging in message-oriented systems, the operations comprising:
receiving, by the one or more processors, one or more subscribe requests from one or more subscriber devices;
receiving, by the one or more processors, at least one publish request from at least one publisher device, the publisher and subscriber devices being loosely coupled through the broker device on a shared cloud platform;
validating, by the one or more processors, the at least one publish request and the one or more subscribe requests to provide validation results; and
determining, by the one or more processors, a message routing schedule based at least in part on the validation results.

15. A system, comprising:
a client-side computing device; and
a computer-readable storage device coupled to the client-side computing device and having instructions stored thereon which, when executed by the client-side computing device, cause one or more processors of the client-side computing device to perform operations for providing secure messaging in message-oriented systems, the operations comprising:
receiving, by the one or more processors, one or more subscribe requests from one or more subscriber devices;
receiving, by the one or more processors, at least one publish request from at least one publisher device, the publisher and subscriber devices being loosely coupled through the broker device on a shared cloud platform;
validating, by the one or more processors, the at least one publish request and the one or more subscribe requests to provide validation results; and
determining, by the one or more processors, a message routing schedule based at least in part on the validation results.
